(19) United States
(12) Patent Application Publication
(10) Pub. No.: US 2020/0194143 A1
(43) Pub. Date: Jun. 18, 2020

(54) POWER CABLE WITH FLEXIBLE PRIMARY BARRIER

(71) Applicant: SCHLUMBERGER TECHNOLOGY CORPORATION, Sugar Land, TX (US)

(72) Inventor: Jinglei Xiang, Lawrence, KS (US)

(21) Appl. No.: 16/711,599

(22) Filed: Dec. 12, 2019

Related U.S. Application Data
(60) Provisional application No. 62/779,983, filed on Dec. 14, 2018.

(51) Int. Cl. H01B 7/282; H01B 7/02; H01B 9/02; H01B 3/44; H01B 13/16; H01B 13/22; H01B 13/14

(52) U.S. Cl. CPC H01B 7/282; H01B 7/0283; H01B 9/02; H01B 13/165; H01B 13/16; H01B 13/22; H01B 13/14; H01B 3/441

(57) ABSTRACT

A technique facilitates construction and use of a power cable in a variety of environments, e.g. downhole environments. The power cable comprises a conductor, e.g. a plurality of conductors. Each conductor is surrounded by an insulation layer which is coated with a graphene-based ink. The graphene-based ink comprises graphene nanostructures and provides a flexible primary barrier coating for the power cable. The flexible primary barrier coating substantially increases fluid resistance of the insulation layer and also reduces transmission of downhole gases into the power cable insulation.

### CROSS-REFERENCE TO RELATED APPLICATIONS

Any and all applications for which a foreign or domestic priority claim is identified in the Application Data Sheet as filed with the present application are hereby incorporated by reference under 37 CFR 1.57. The present application claims priority benefit of U.S. Provisional Application No. 62/779,983, filed Dec. 14, 2018, the entirety of which is incorporated by reference herein and should be considered part of this specification.

### BACKGROUND

In many hydrocarbon well applications, power cables are employed to deliver electric power to various devices. For example, power cables are used to deliver electric power to electric submersible pumping systems which may be deployed downhole in wellbores. The power cables are subjected to harsh working environments containing corrosives, e.g. corrosive gases, elevated temperatures, high pressures, and vibrations. To protect power cable conductors from gases such as carbon dioxide (CO₂) and hydrogen sulfide (H₂S), an extruded continuous lead barrier is provided around the conductors to block gas permeation. However, the continuous lead barrier is relatively heavy and can be an undesirable material for handling and use in a variety of downhole applications.

### SUMMARY

In general, a methodology and system are provided which facilitate construction and use of a power cable in a variety of environments, e.g. downhole environments. The power cable comprises a conductor, e.g. a plurality of conductors. Each conductor is surrounded by an insulation layer which is coated with a graphene-based ink. The graphene-based ink comprises graphene nanostructures and provides a flexible primary barrier coating for the power cable. The flexible primary barrier coating substantially increases fluid resistance of the insulation layer and also reduces transmission of downhole gases into the power cable.

However, many modifications are possible without materially departing from the teachings of this disclosure. Accordingly, such modifications are intended to be included within the scope of this disclosure as defined in the claims.

### BRIEF DESCRIPTION OF THE FIGURES

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 is a schematic illustration of a well system comprising an example of an electric power cable coupled with an electric submersible pumping system, according to an embodiment of the disclosure;

FIG. 2 is an orthogonal view of an example of a power cable having a multiphase conductor assembly, according to an embodiment of the disclosure;

FIG. 3 is an illustration of another example of a power cable having a multiphase conductor assembly, according to an embodiment of the disclosure;

FIG. 4 is a graphical illustration showing the reduced transmission of carbon dioxide with respect to an insulation layer coated with a properly prepared graphene-based ink, according to an embodiment of the disclosure;

FIG. 5 is another graphical illustration showing the reduced transmission of carbon dioxide with respect to an insulation layer coated with a properly prepared graphene-based ink, according to an embodiment of the disclosure;

FIG. 6 is a flow chart illustrating an operational example for preparing a downhole power cable having a primary barrier coating formed of a graphene-based ink, according to an embodiment of the disclosure;

FIG. 7 is a flow chart illustrating an operational example for preparing a graphene-based ink, according to an embodiment of the disclosure; and

FIG. 8 is a schematic illustration of an example of a manufacturing layout for preparation of insulated conductors with a primary barrier coating formed of a graphene-based ink, according to an embodiment of the disclosure.

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

The present disclosure generally relates to a methodology and system related to power cables which may be used in a variety of environments, e.g. downhole environments. The power cable comprises a conductor, e.g. a plurality of conductors. Each conductor is surrounded by an insulation layer which is coated with a graphene-based ink. The graphene-based ink comprises graphene nanostructures and provides a flexible primary barrier coating for the power cable.

The flexible primary barrier coating substantially increases fluid resistance of the insulation layer and also reduces transmission of downhole gases into the power cable. Consequently, the power cable is particularly amenable for use in harsh, downhole environments for powering electric submersible pumping systems and/or other downhole systems.

According to an embodiment, the power cable may be constructed via a process involving coating a polymeric substrate with the graphene-based ink. The graphene-based ink is readily coated to a surface of interest, e.g. a polymeric insulation surface, to reduce transmission of downhole fluid and gases to the insulation. In some embodiments, the power cable may comprise a conductor or a plurality of conductors each insulated by an insulation layer formed of ethylene propylene diene monomer (EPDM) rubber or other suitable insulation material. The graphene-based ink effectively forms a coating which can serve as a flexible primary barrier coating able to block or reduce transmission therethrough of downhole fluid and gases.

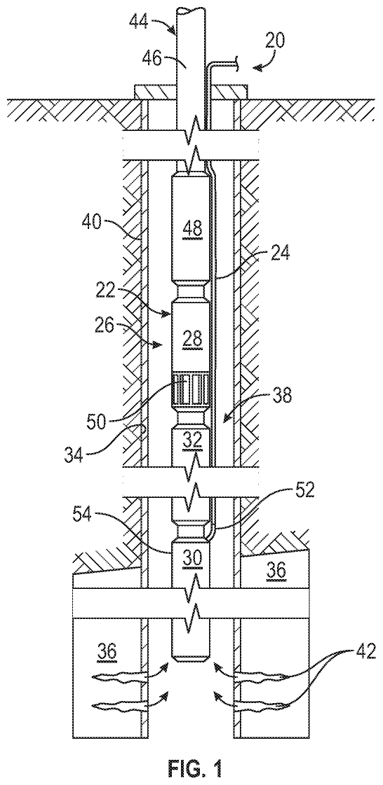

Referring generally to FIG. 1, an example is provided of a downhole system which may be powered via a power cable utilizing a flexible primary barrier coating formed of graphene-based ink. In this embodiment, a well system 20 is illustrated as comprising an electrically powered system 22 which receives electric power via an electric power cable 24. By way of example, the electrically powered system 22 may be in the form of an electric submersible pumping system 26, and the power cable 24 may be constructed to withstand high temperatures and harsh environments. Although the electric submersible pumping system 26 may have a wide variety of components, examples of such components comprise a submersible pump 28, a submersible motor 30, and a motor protector 32.

In the example illustrated, electric submersible pumping system 26 is designed for deployment in a well 34 located within a geological formation 36 containing, for example, petroleum or other desirable production fluids. A wellbore 38 may be drilled and lined with a wellbore casing 40, although the electric submersible pumping system 26 (or other type of electrically powered system 22) may be used in open hole wellbores or in other environments exposed to high temperatures and harsh conditions. In the example illustrated, however, casing 40 may be perforated with a plurality of perforations 42 through which production fluids flow from formation 36 into wellbore 38. The electric submersible pumping system 26 may be deployed into a wellbore 38 via a conveyance or other deployment system 44 which may comprise tubing 46, e.g. coiled tubing or production tubing. By way of example, the conveyance 44 may be coupled with the electrically powered system 22 via an appropriate tubing connector 48.

In the example illustrated, electric power is provided to submersible motor 30 by electric power cable 24. The submersible motor 30, in turn, powers submersible pump 28 which draws in fluid, e.g. production fluid, into the pumping system through a pump intake 50. The fluid is produced or moved to the surface or other suitable location via tubing 46. However, the fluid may be pumped to other locations along other flow paths. In some applications, for example, the fluid may be pumped along an annulus surrounding conveyance 44. In other applications, the electric submersible pumping system 26 may be used to inject fluid into the subterranean formation or to move fluids to other subterranean locations.

As described in greater detail below, the electric power cable 24 is designed to consistently deliver electric power to the submersible pumping system 26 over long operational periods when subjected to high temperatures due to high voltages and/or high temperature environments. The construction of power cable 24 also facilitates long-term operation in environments having high pressures, deleterious fluids, e.g. problematic gases, and/or other harsh conditions. The power cable 24 is connected to the corresponding, electrically powered component, e.g. submersible motor 30, by an electrical connector 52, e.g. a suitable pothead assembly. The electrical connector 52 provides sealed and protected passage of the power cable conductor or conductors through a housing 54 of submersible motor 30.

Depending on the application, the power cable 24 may comprise a plurality of electrical conductors protected by the insulation system. In various submersible pumping applications, the electrical power cable 24 is configured to carry three-phase current. In this type of application, the submersible motor 30 is in the form of a three-phase motor powered by the three-phase current delivered through three electrical conductors of power cable 24.

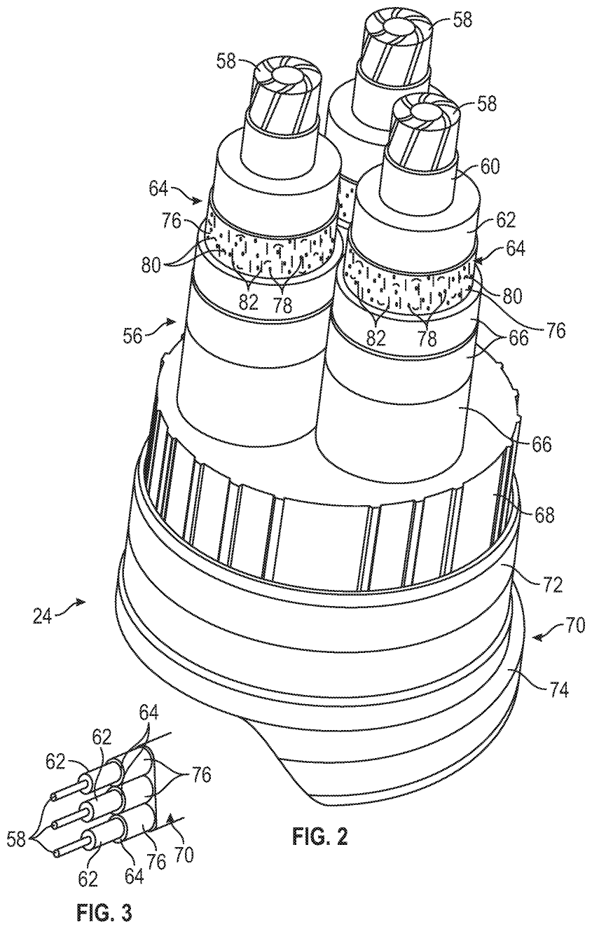

Referring generally to FIG. 2, an example of electric power cable 24 is illustrated. In this example, the power cable 24 comprises a multi-phase conductor assembly 56 having a plurality of electrical conductors 58 for the separate phases. By way of example, the power cable 24 may be in the form of a three-phase power cable having three conductors 58 for supplying the three-phase power to, for example, electric submersible pumping system 26.

The power cable 24 may be constructed with a variety of protective layers, insulative layers, and other layers depending on the application and environment in which it is used. The number of conductors 58 also may vary according to the parameters of a given application and may be arranged in, for example, a generally circular configuration as illustrated or a generally flat configuration as illustrated in FIG. 3. In the embodiments illustrated in FIGS. 2 and 3, the power cable 24 comprises a plurality of the electrical conductors 58, e.g. three electrical conductors, which may be made from copper or other suitable, conductive material.

Referring again to the embodiment of FIG. 2, each conductor 58 may be surrounded by a conductor shield 60, an insulation layer 62, and a flexible primary barrier coating 64 applied to the insulation layer 62. Depending on operational and/or environmental parameters, the power cable 24 may have various other layers 66, e.g. various secondary barrier layers or other types of protective layers. In the embodiments illustrated in FIGS. 2 and 3, the power cable 24 is constructed as a leadfree power cable without a conventional protective lead layer.

Additionally, the conductors 58 and their dedicated surrounding layers may be collectively secured within additional layers. For example, the conductors 58 and their dedicated surrounding layers (60, 62, 64, 66) may be seated in a cable jacket 68 which may be formed of an insulative material. The cable jacket 68 may be surrounded by an armor structure 70 having, for example, a first layer of armor 72 and a second layer of armor 74. The armor layers 72, 74 may be formed of a suitable metal or other material able to provide the desired production.

In the examples illustrated, the flexible primary barrier coating 64 is in the form of a graphene-based ink 76 which is coated onto the insulation layer 62. In some embodiments, the insulation layer 62 is in the form of a polymeric substrate. The polymeric substrate 62 may comprise suitable insulation materials, such as rubber formed of ethylene propylene diene monomer (EPDM), polyetheretherketone (PEEK), fluorinated ethylene propylene (FEP), or other suitable insulative material.

Additionally, the graphene-based ink 76 may comprise a variety of materials. According to an embodiment, the graphene-based ink 76 may comprise graphene nanostructures 78, a binder 80, and a viscosity modifier 82. Depending on the application, the graphene nanostructures 78 may comprise graphene nanosheets, graphene nanoplatelets, or other suitable graphene nanostructures 78. The graphene nanostructures 78 serve to provide the primary gas and fluid blocking component in the graphene-based ink 76.

According to one example, the graphene nanostructures 78 may be in the form of graphene nanosheets which are thermally exfoliated from graphite intercalated compound. This type of graphene nanostructure retains desirable chemical, electrical, mechanical, and barrier properties.

The binder 80 helps the barrier coating 64 form a uniform layer without cracks. The binder 80 effectively physically connects individual graphene nanostructures 78 into a “cross-link” network. Examples of suitable binders 80 include ionic surfactants such as sodium dodecylsulfonate (SDS) surfactants, sodium dodecylbenzenesulfonate (SDBS) surfactants, or polystyrenesulfonate (PSS) surfactants. Other examples of suitable binders include non-ionic surfactants such as polyethylene oxide (PEO) surfactants or polypropylene oxide (PPO) surfactants. Suitable surfactants may be available under tradenames such as Triton™ X-100; Tween™85; Tween™80; or Pluronic™P123. Other examples of suitable binders include polymers/oligomers such as polyvinylpyrrolidone (PVP), polyvinyl alcohol (PVA), polyethylene imine (PEI), mono-, di-, or multi-functional acrylates, and ionic/nonionic cellulose ethers, e.g. Aqualon™ EC-N4.

The viscosity modifier 82 may be used to help obtain a desirable viscosity to enhance the downstream processability of the graphene-based ink 76. For example, the viscosity modifier 82 may comprise solvents which are compatible with both the binder 80 and the graphene nanostructures 78 and which do not create coagulation or precipitation of the solids in the graphene-based ink 76. Like solvents, monomers, or oligomers also can be used to adjust the viscosity of the graphene-based ink 76. Examples of suitable viscosity modifiers 82 include surface treated or nontreated mineral filler such as fumed silica (Aerosiff), precipitated silica (Hisiff), and clay (Satinetone™ or Translink™).

Depending on the parameters of a given application, the other components of power cable 24 also may be made from a variety of materials. By way of example, the conductors 58 may be made of copper and the conductor shields 60 may be made from a high density polyethylene (HDPE), polypropylene, or ethylene propylene diene material (EPDM). As described above, the insulation layer 62 may be made from suitable insulation materials for use in a downhole, high temperature environment. The barrier layers 66 may be formed from a fluoropolymer or other suitable material and the cable jacket 68 may be formed from an oil resistant EPDM, nitrile rubber, or other suitable material. The one or more layers of armor 72, 74 may be formed from metal materials such as galvanized steel, stainless steel, MONEL′ or other suitable materials.

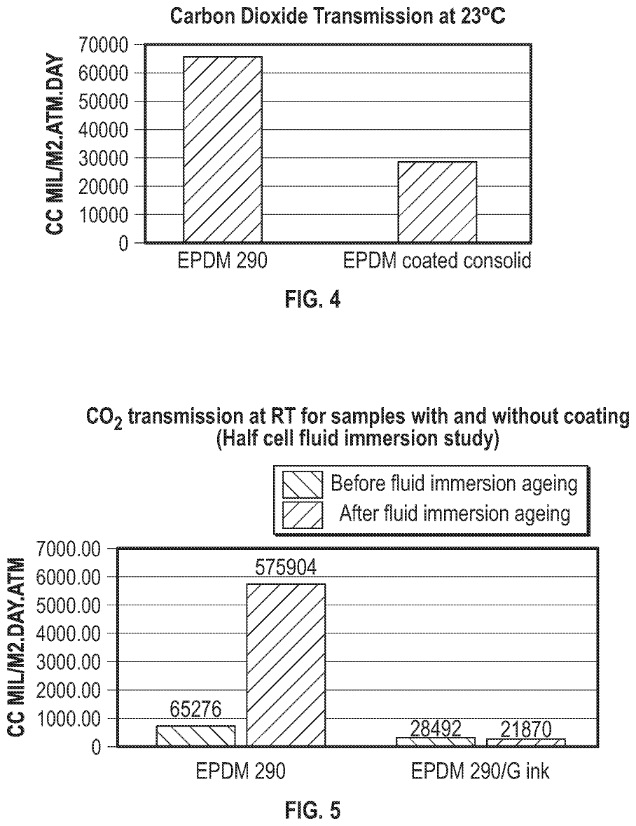

Referring generally to FIG. 4, a graphical illustration is provided to show the substantial resistance to gas transmission through the graphene-based ink 76 when the barrier layer 64 is properly applied onto insulation layer 62. In this graphical example, tests were performed at 23° C. to determine the transmission of carbon dioxide at the insulation layer 62 when formed of EPDM 290. The illustrated graph shows the carbon dioxide transmission for uncoated EPDM 290 (left side) and for EPDM 290 properly coated with graphene-based ink 76. The decrease in carbon dioxide transmission is substantial.

Additional testing was performed in a two port cell to test fluid resistance of the flexible primary barrier coating 64 when formed of graphene-based ink 76. In this test, a sample material was clamped between two half cells filled with two different types of liquids. In this setting, one side of the cell was filled with a reference oil (IRM 903) and the other side of the cell was filled with water. This setup is representative as to what the sample material would be exposed to in a downhole environment.

In a first test the sample material was uncoated EPDM; and in a second test the sample material was the same EPDM but with barrier coating 64 formed of graphene-based ink 76. The testing was conducted at 60° C. in an air oven for 70 hours. Before and after the fluid exposure testing, gas permeability of the sample materials was tested as indicated by the test results shown in the graph of FIG. 5.

It was observed from this testing that the uncoated EPDM sample material swelled and became very flexible and soft. On the other hand, the coated EPDM material sample maintained its original stiffness and had minimal swelling. As illustrated in FIG. 5 (left side), the uncoated sample material had a very substantial increase in gas transmission after the fluid exposure. However, the sample material coated with the graphene-based ink 76 had almost no change (even a small reduction) in the gas transmission through the insulation material as shown in FIG. 5 (right side). The testing demonstrated that the barrier coating 64 formed of graphene-based ink 76 is very effective in blocking hydrocarbon ingression into the insulation layer 62. When the insulation layer 62 is formed of EPDM (and other similar insulation materials), the original polymer microstructure of the EPDM also is preserved.

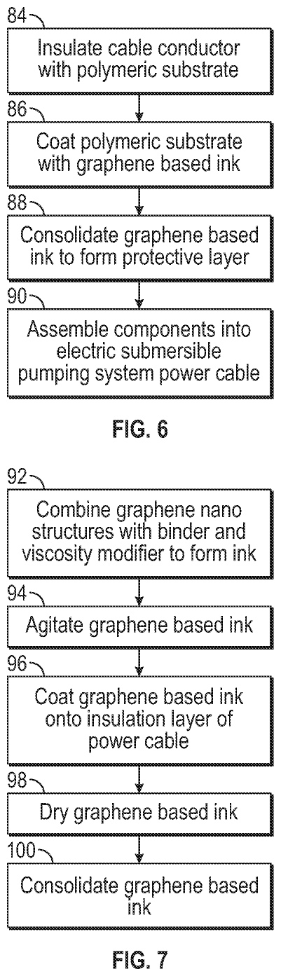

Referring generally to FIG. 6, a flowchart is provided to illustrate an example of a methodology for constructing power cable 24 with a flexible primary barrier coating 64. This type of power cable 64 is very amenable to providing power in downhole applications, e.g. providing power to electric submersible pumping system 26. In this example, each cable conductor 58 is initially insulated via insulation layer 62 which is in the form of a polymeric substrate, as indicated by block 84. The polymeric substrate 62 is located between the corresponding conductor 58 and the external armor structure 70. Each insulation layer/polymeric substrate 62 may then be coated with graphene-based ink 76, as indicated by block 86.

The graphene-based ink 76 is then consolidated to form a protective layer in the form of flexible barrier coating 64, as indicated by block 88. This process may be performed for each cable conductor 58 so that the components, e.g. cable conductors 58 and surrounding layers, may be assembled into a suitable electric submersible pumping system power cable 24, as indicated by block 90. In various embodiments, the power cable 24 is constructed as a multiphase, e.g. three-phase, power cable for use in downhole applications.

An operational example regarding preparation of the graphene-based ink 76 used to form flexible barrier coating 64 is provided via the flowchart of FIG. 7. In this example, graphene nanostructures 78 are combined with binder 80 and viscosity modifier 82 to prepare the graphene-based ink 76, as indicated by block 92. The mixture of graphene-based ink is then agitated, as indicated by block 94. Once agitated, the graphene-based ink 76 may be coated onto the insulation layer 62 of the power cable 24, as indicated by block 96. The graphene-based ink 76 may be coated onto each insulation layer 62 surrounding each conductor 58 for use in construction of power cable 24.

After application of the graphene-based ink 76 onto each insulation layer 62, the graphene-based ink 76 is dried, e.g. allowed to dry over a given time period, as indicated by block 98. The graphene-based ink 76 is then consolidated to reduce porosity so as to better prevent transmission of undesirable fluid therethrough, as indicated by block 100. In some applications, the consolidation helps reduce porosity that can develop during drying of the ink 76.

With respect to agitation, the graphene-based ink 76 may be agitated via various techniques, e.g. ultrasound, paint shaker, manual mechanical shaking, or other suitable agitation techniques. The agitation of the graphene-based ink 76 before use ensures that the graphene nanostructures 78 are dispersed throughout the ink without forming large agglomerates.

During coating of the graphene-based ink 76 onto insulation layer 62, a uniform coating is applied to ensure there are no or minimal voids or gaps in the barrier layer 64. Application of a uniform coating of the graphene-based ink 76 also ensures that chemical compatibility is uniform throughout the barrier layer 64, e.g. the barrier layer 64 is constructed without weak spots and without uneven areas. The graphene-based ink 76 may be uniformly coated onto the insulation layer 62 by, for example, spraying the graphene-based ink 76 onto insulation layer 62 or by immersing the insulation layer 62 in a bath of the graphene-based ink 76.

After the graphene-based ink 76 is uniformly applied to the insulation layer 62, the drying of the ink 76 ensures that solvents or organic volatiles evaporate to leave a homogeneous film on the insulation layer 62, e.g. polymeric substrate. Micropores or other voids can be created during drying due to, for example, evaporation of the solvents. However, consolidation techniques may be used to remove such porosity. Consolidation effectively prevents leak paths so that fluid cannot migrate through the barrier layer 64 and into the underlying substrate (insulation layer 62).

In some embodiments, consolidation may be performed by applying pressure to the dried graphene-based ink 76 so as to squeeze the material and remove porosity, e.g. remove undesirable voids. The consolidation process also may be performed during manufacturing of the power cable 24. For example, the graphene-based ink 76 may be applied to the insulation layer 62 subsequent to the insulation layer 62 being extruded during manufacturing of the power cable 24. If the insulation layer 62 is formed of EPDM or various other suitable polymeric insulating materials, the insulation layer 62 may be extruded and then vulcanized via a high-pressure steam, e.g. a steam at 250 psi in a steam tube. The same pressure can be used to generate force on the coating of graphene-based ink 76 so as to collapse pores/voids that potentially can be introduced during application and/or drying of the graphene-based ink 76.

It should be noted the high pressures experienced downhole in a variety of wellbore applications also can further consolidate the graphene-based ink 76. Additionally, the pressure to consolidate the graphene-based ink 76 may be provided via various types of pressure containers through which the coated insulation layer 62 is passed. Other pressure application devices, e.g. presses, also may be used to ensure the graphene-based ink 76 is properly consolidated and formed into barrier layer 64.

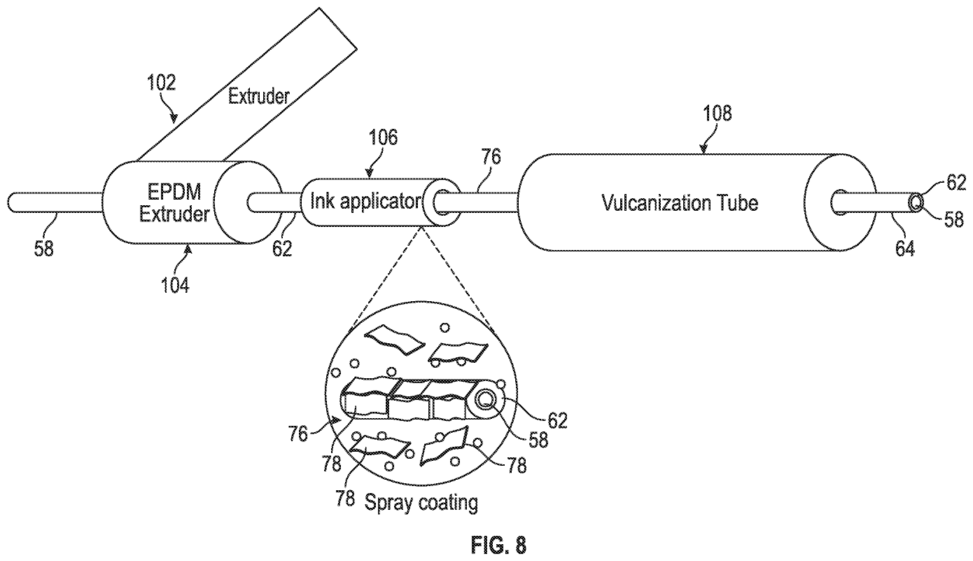

Referring generally to FIG. 8, an example of a manufacturing layout for constructing power cable 24 is illustrated. In this example, each conductor 58 is fed into an extruder system 102 having a polymeric substrate extruder 104, e.g. EPDM extruder. In this embodiment, the insulation layer 62 is formed of an elastomeric material. The extruder 104 applies the elastomeric material/insulation layer 62 to the corresponding conductor 58 and delivers the insulated conductor 58 to an ink applicator 106 for coating of the extruded insulation layer 62.

The ink applicator 106 may have different configurations depending on the coating technique used to apply the graphene-based ink 76 to the exterior of insulation layer 62. For example, the ink applicator 106 may be a spray applicator which sprays the graphene-based ink 76 onto the insulated conductor to form a homogeneous layer of the graphene-based ink 76 covering the insulation layer 62. According to another embodiment, the ink applicator 106 may utilize a graphene-based ink bath into which the insulated conductor is immersed. For example, the conductor 58 surrounded by extruded insulation layer 62 may be guided through the graphene-based ink bath to allow deposition of the graphene-based ink 76 directly onto the exterior surface of the insulation layer 62.

After coating of the graphene-based ink 76, the conductor 58 (along with the insulation layer 62 and the coating of graphene-based ink 76) is delivered into a vulcanization tube 108. According to one example, the conductor 58 is moved into the vulcanization tube 108 while the coating of graphene-based ink 76 is wet. In this embodiment, the vulcanization tube 108 is in the form of a pressurized steam tube in which the polymeric substrate insulation layer 62 undergoes vulcanization which initiates cross-linking of the elastomeric material forming insulation layer 62 and also consolidates the coating of graphene-based ink 76 to help complete the formation of barrier layer 64. It should be noted drying of the graphene-based ink 76 may occur prior to, during, and/or subsequent to the vulcanization stage.

This process may be repeated for each conductor 58 of the power cable 24. The plurality of conductors 58 with their accompanying layers may then be combined in the cable jacket 68 and armor structure 70 to complete the desired power cable 24. In downhole electric submersible pumping system applications, the power cable 24 may be constructed with three conductors 58 for delivery of three-phase power. However, other types of power cables 24 with single conductors 58 or other numbers of conductors 58 may be constructed according to processes described herein.

Additionally, the number and type of insulative layers also may be selected according to the parameters of a given operation and/or environment in which the power cable 24 is utilized. The graphene-based ink 76 may have various mixtures and may be applied via various spraying techniques, immersion techniques, or other suitable application techniques. The insulation and barrier layers also may be formed via insulating tapes or by other types of materials wrapped or otherwise positioned about each phase.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A method of constructing a power cable, comprising:
insulating a power cable conductor with a polymeric substrate;
coating the polymeric substrate with a graphene-based ink;
consolidating the graphene-based ink to form a flexible protective layer of the graphene-based ink having a reduced porosity; and
assembling the power cable conductor, the polymeric substrate, and the flexible protective layer of the graphene-based ink into an electric submersible pumping system power cable for use in providing power to an electric submersible pumping system.

2. The method as recited in claim 1, further comprising forming the graphene-based ink with graphene nanostructures, a binder, and a viscosity modifier

3. The method as recited in claim 1, further comprising forming the graphene-based ink with graphene nanosheets, a binder, and a viscosity modifier.

4. The method as recited in claim 1, further comprising forming the graphene-based ink with graphene nanoplatelets, a binder, and a viscosity modifier.

5. The method as recited in claim 2, further comprising agitating the graphene-based ink to ensure the graphene-based nanostructures are dispersed throughout the graphene-based ink.

6. The method as recited in claim 1, wherein coating comprises spraying the graphene-based ink onto the polymeric substrate.

7. The method as recited in claim 1, wherein coating comprises immersing the polymeric substrate in the graphene-based ink.

8. The method as recited in claim 1, wherein consolidating comprises applying pressure to the flexible protective layer of graphene-based ink.

9. The method as recited in claim 1, further comprising providing the electric submersible pumping system power cable with a protective armor layer.

10. A method comprising:
combining graphene nanostructures with a binder and a viscosity modifier to form a graphene-based ink;
agitating the graphene-based ink;
coating the graphene-based ink onto an insulation layer of a power cable;
drying the graphene-based ink; and
consolidating the graphene-based ink.

11. The method as recited in claim 10, further comprising providing the insulation layer around each conductor of a multiphase power cable.

12. The method as recited in claim 11, wherein providing comprises extruding the insulation layer onto each conductor of the multiphase power cable.

13. The method as recited in claim 12, wherein coating comprises routing each insulation layer through an ink applicator following extrusion of the insulation layer.

14. The method as recited in claim 13, wherein consolidating the graphene-based ink comprises consolidating the graphene-based ink while vulcanizing the insulation layer.

15. The method as recited in claim 10, wherein coating comprises spraying the graphene-based ink onto the insulation layer.

16. The method as recited in claim 10, wherein coating comprises immersing the insulation layer in the graphene-based ink.

17. The method as recited in claim 10, further comprising forming the insulation layer with ethylene propylene diene monomer (EPDM) rubber.

18. A system, comprising:
a power cable for use in downhole environments, the power cable having a plurality of conductors with each conductor surrounded by an insulation layer and each insulation layer coated with a graphene-based ink, the plurality of conductors being collectively surrounded by an external armor layer.

19. The system as recited in claim 18, wherein the insulation layer is formed from ethylene propylene diene monomer (EPDM) rubber.

20. The system as recited in claim 18, wherein the insulation layer is extruded and the graphene-based ink is sprayed onto the extruded insulation layer.
